(19) United States
(12) Patent Application Publication
(10) Pub. No.: US 2010/0278958 A1
(43) Pub. Date: Nov. 4, 2010

(54) ONE-STEP ADHESIVE-MEDIUM-FINISHING TOOL AND METHODS OF USE

(76) Inventors: Christopher David Chamberlain, Kremmling, CO (US); Paula Ohri Chamberlain, Kremmling, CO (US)

Correspondence Address: Leyendecker & Lemire, LLC, 9137 E. Mineral Circle, Suite 280, Centennial, CO, 80112, US

(21) Appl. No.: 12/771,913

(22) Filed: Apr. 30, 2010

Related U.S. Application Data
(60) Provisional application No. 61/175,360, filed on May 4, 2009.

(51) Int. Cl. A21C 11/00; B23P 19/04; B28B 3/00; B65D 5/72

(52) U.S. Cl. 425/458; 29/428; 425/87; 222/567

(57) ABSTRACT

A tool for finishing or smoothing-out an applied bead of adhesive medium material, such as caulking, at substantially the same time as the bead is laid is disclosed. The finishing tool can be an add-on to an existing adhesive-medium-applicator tool, or can be fabricated with the applicator tool such that the finishing tool and the dispensing end of the applicator tool are a unit. In many embodiments, the finishing tool has a flexibly rigid, angled blade-like member that trails the dispensing end of the applicator tool. The edges of the finishing tool pliably engage two surfaces on each side of a target jointed surface in order to both finish the bead of adhesive-medium material and to gather excess material and redistribute it to help reduce the waste of adhesive-medium material.

### CROSS-REFERENCE TO RELATED APPLICATIONS

This patent application claims the benefit of U.S. Patent Application No. 61/175,360, filed on May 4, 2009, which is hereby incorporated by reference for all purposes.

### BACKGROUND OF THE INVENTION

Caulking beads are difficult to consistently and efficiently lay down and then finish. They generally require at least a two-step process, in which the finishing step typically involves the passage of a either a tool, piece of cardboard, etc., or even a user's finger, over the just applied bead of caulking material over a jointed surface.

Many attempts have been made to introduce tools in the market for making it easier to finish a bead of caulk, as well as other types of adhesive mediums. Most solutions in the art involve a multiple-step process where a user applies an adhesive medium such as caulk on a target jointed surface, and then subsequently, as the adhesive medium cures or in some cases after the adhesive medium has cured, the user applies a tool to basically scrape away excess adhesive medium, while trying to properly and attractively shape the adhesive to remain at the jointed surface.

Examples of these types of solutions include:
U.S. Pat. No. 7,644,464 to Bommarito discloses a stand-alone caulk-finishing caulk tool that is used in a separate step from the application of a caulk bead. The finishing component of this tool is a bristle structure.
U.S. Pat. No. 7,127,769 to Chang et al. discloses a multi-purpose finishing tool that is used after the application of caulking material. The device can also store extra storing caps for caulking material and a clip to allow the finishing tool 1 to be attached to a caulking gun until needed for use.
U.S. Pat. No. 4,586,890 to Marchbanks discloses a stand-alone caulk-bead tool with various edges and shapes on the various surfaces on its block. Once again, this solution requires that a bead of caulk be finished in a separate process from the application process.
U.S. Patent Application Publication No. US 2007/0209216 to Accumanno discloses another stand-alone tool for the removal and smoothing of caulk.

Others have attempted to offer a relatively complex means to finish a bead of caulk at substantially the same time that the bead of caulk. For example:
U.S. Pat. No. 4,932,094 to McCowin discloses a complex liquid applicator tool (for caulk, glue, or sealant) with a rotatable brush mounted on the tool housing, with a pneumatic motor contained within the housing to drive the rotatable brush. This solution has obvious problems, not the least of which is its complexity and the associated relatively high cost of manufacture.
U.S. Pat. No. 5,033,951 to Cook discloses a caulking applicator and striking tool. This solution is basically a standard caulking gun that has a very elongated and shaped discharge tube for the caulk, with the intent being that the shape and length of the tube would hopefully allow a user to better force caulking into cracks, as well as attempt to provide some sort of finishing during the process. However, this schema simply is not very effective from a finishing stand point, as the specialized tube cannot gather and remove excess caulking as the bead is laid down.

What is needed is a more-reliable and efficient means to apply adhesive medium such as caulk. In addition, such a solution needs to structurally simple and be easy to manufacture so that it can be relatively inexpensive for most users to buy, as well as easy to use.

### BRIEF DESCRIPTION OF THE DRAWINGS

FIG. 1 depicts an isometric view of one embodiment of a one-step adhesive-medium-finishing tool, wherein this particular embodiment is manufactured using an injection-molding process.

FIG. 2 depicts an x-axis cut-away view of the same embodiment depicted in FIG. 1.

FIG. 3 depicts a y-axis cut-away view of the same embodiment depicted in FIG. 1.

FIG. 4 depicts a front view of the same embodiment depicted in FIG. 1.

FIG. 5 depicts a rear view of the same embodiment depicted in FIG. 1.

FIG. 6 depicts a left-side view of the same embodiment depicted in FIG. 1. The right-side of this embodiment is a minor image of FIG. 6; therefore, it is not depicted.

FIG. 7 depicts a bottom view of the same embodiment depicted in FIG. 1, including a support member between the attachment member and the working member.

FIG. 8 depicts an alternative embodiment of a one-step adhesive-medium-finishing tool, wherein this particular embodiment has a clamp-type device as an attachment member, as well as a means to attach interchangeable working members to the finishing tool.

FIG. 9 depicts an isometric view of a caulking gun, with one embodiment of a one-step adhesive-medium-finishing tool attached, being used to simultaneously apply and finish a bead of an adhesive-medium material.

FIG. 10 depicts a close-up view of one embodiment of a one-step adhesive-medium-finishing tool attached to the dispensing end of an adhesive-medium-application tool.

### DETAILED DESCRIPTION

### Overview

The various embodiments of the invention encompass a device used to smooth and finish a bead of an adhesive medium that has been applied to a jointed surface within the same motion and operation of that of applying the bead of adhesive medium; that is, the finishing tool in these embodiments allows the application of and finishing of adhesive medium material in one step.

Using a caulking task as an example, the device is coupled to the discharge end of a typical caulking gun (or even just a stand-alone tube of caulking material), and as a user causes the caulking tool to discharge along a jointed surface, the device tip trails the applied caulk bead and both smoothes the caulk bead and gathers up the excess caulk in the same motion. Therefore, the caulking task can be performed in one step. Conversely, in existing art, the caulk finishing takes place using a separate tool (or often the user's finger) after the entire caulk bead has been applied.

For convenient reference, much of this disclosure focuses on a caulking application. However, it is important to note that a caulking application is but one of myriad adhesive-medium applications that the embodiments described herein can be applied to. One ordinarily skilled in the art would easily appreciate that the finishing tool embodiments can be applied to caulk, resin, glue, epoxy, grout, drywall mud, and chinking, as well as any similar adhesive mediums.

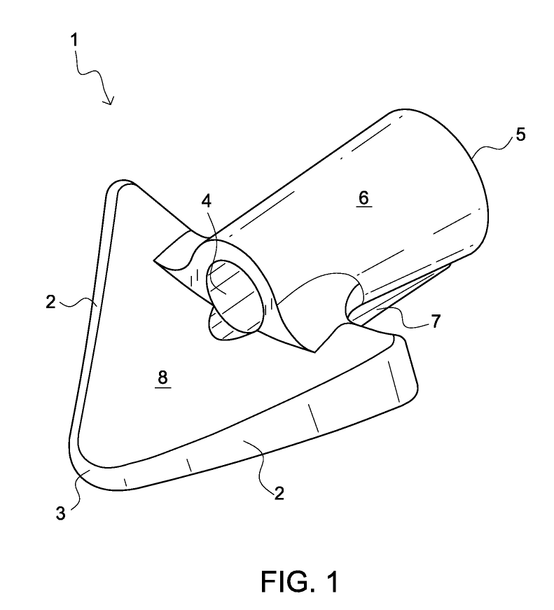

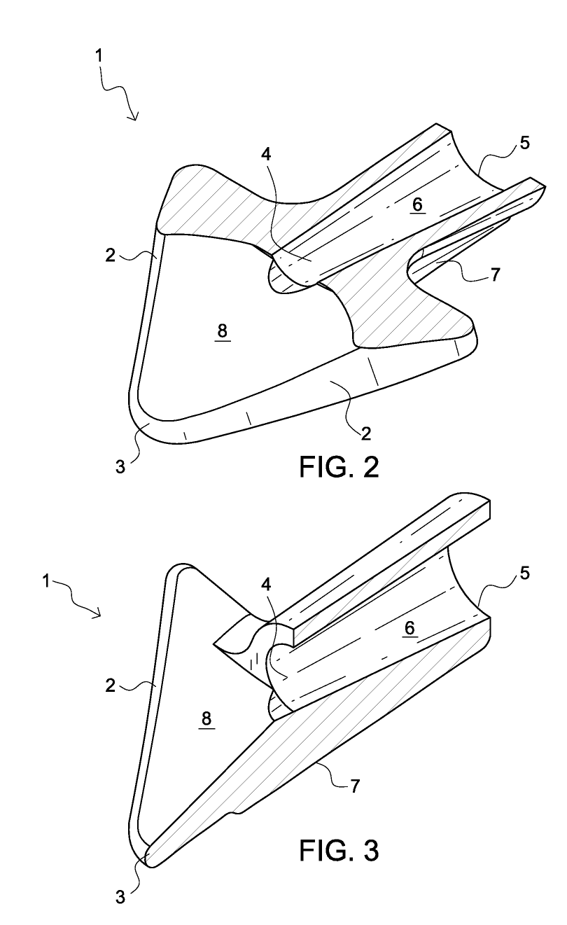

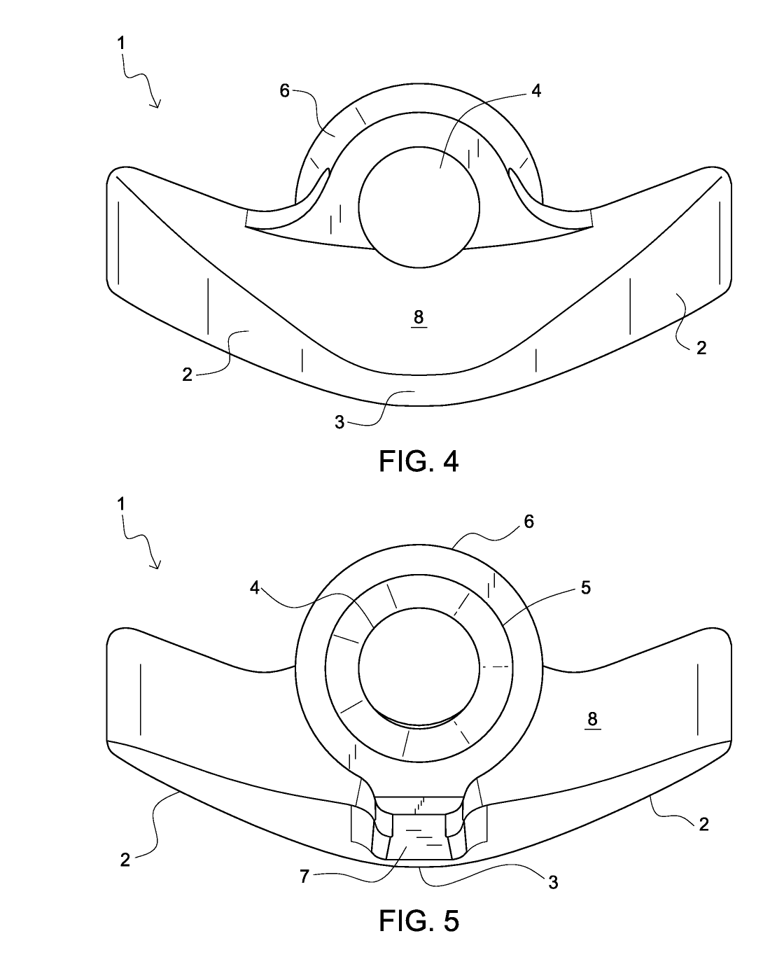

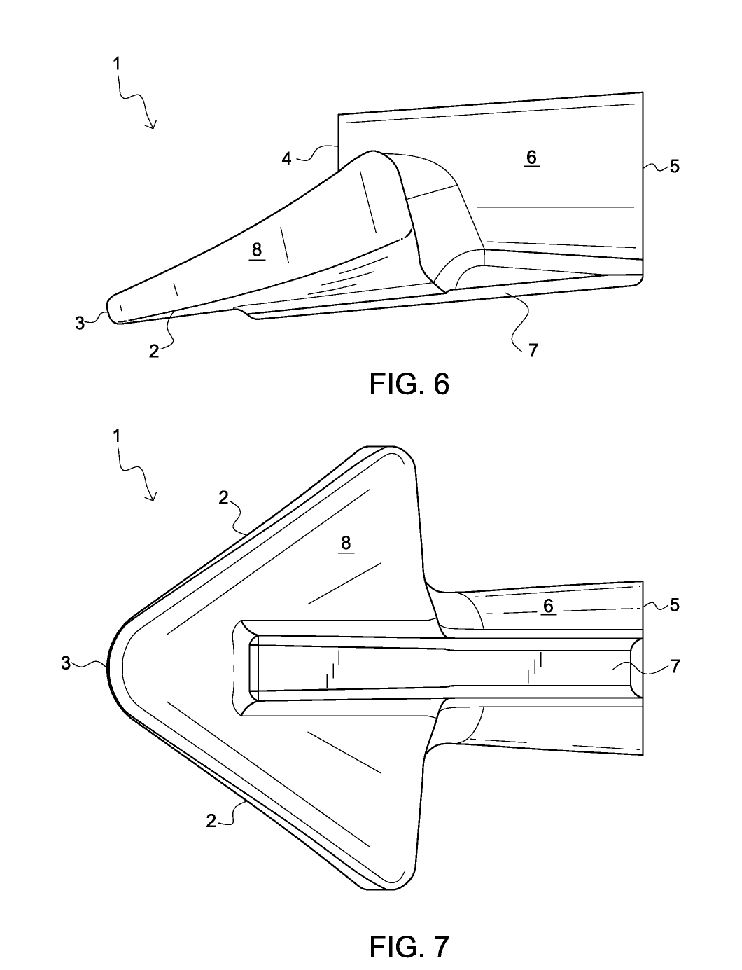

Referring to FIGS. 1-10, one embodiment of a finishing tool 1 encompasses an arrow-like-shaped working member coupled with an attachment member. The attachment member facilitates the coupling of the finishing tool to the elongated dispensing end of an adhesive-medium-applicator tool, such as a caulking gun or caulking tube. In many cases, the material that is used to fabricate the finishing tool is comprised of a polymer or vulcanized rubber, but other materials, including composites, can be used. The working member of the finishing tool is designed to be flexibly rigid, and is adapted to pliably contact the adjoining surfaces of a target joint. The angles of the working edges of the finishing tool selected for use by a user are generally somewhere between 45 degrees and 90 degrees, though other angles (particularly larger angles) are possible for specialized jointed surfaces, with the general goal being to have an angling that will best allow the finishing tool to capture excess adhesive medium, and to act as a guide for the user as the bead of adhesive medium is being laid between the two surfaces of the jointed interface.

An option available to basic embodiment is a means to change-out the working member from the attachment member and change-out the working member of the finishing tool for cleaning, maintenance, or selection of a differently-sized and/or shaped working member for the application.

### TERMINOLOGY

The terms and phrases as indicated in quotes (“ ”) in this section are intended to have the meaning ascribed to them in this Terminology section applied to them throughout this document, including the claims, unless clearly indicated otherwise in context. Further, as applicable, the stated definitions are to apply, regardless of the word or phrase's case, to the singular and plural variations of the defined word or phrase.

The term “or”, as used in this specification and the appended claims, is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “in one variation” in various places in the specification are not necessarily all meant to refer to the same embodiment.

The term “couple” or “coupled”, as used in this specification and the appended claims, refers to either an indirect or a direct connection between the identified elements, components, or objects. Often the manner of the coupling will be related specifically to the manner in which the two coupled elements interact.

The term “removable”, “removably coupled”, “readily removable”, “readily detachable”, and similar terms, as used in this patent application specification (including the claims and drawings), refer to structures that can be uncoupled from an adjoining structure with relative ease (i.e., non-destructively and without a complicated or time-consuming process) and can also be readily reattached or coupled to the previously adjoining structure.

Directional and/or relational terms such as, but not limited to, left, right, nadir, apex, top, bottom, vertical, horizontal, back, front, and lateral are relative to each other, are dependent on the specific orientation of an applicable element or article, are used accordingly to aid in the description of the various embodiments, and are not necessarily intended to be construed as limiting.

As applicable, the terms “about” and “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

The term “flexibly rigid”, as used in this specification and the appended claims, refers to a structural integrity that allows a structure to substantially maintain its manufactured shape, yet allows for some flexing of the manufactured shape to facilitate effective applied uses of the manufactured structure.

The term “pliably interact”, and similar terms, as used in this specification and the appended claims, refers to the ability of the working interface of an embodiment of an adhesive-medium finishing tool to make contact with the adjoining surfaces of a target jointed surface with some elastic deformation occurring as some force is exerted to ensure that the working interface of the finishing tool is able to effectively capture excess adhesive-medium material, while leaving a properly finished sealed/adhered joint.

The term “substantially rigid”, as used in this specification and the appended claims, is somewhat similar to the term “flexibly rigid”; however, it refers to a structural integrity that generally requires that a structure to substantially maintain its manufactured shape, yet allows some deliberate manipulation of the shape and size to accommodate the coupling or mating with a second structure. An example is a metal framework that can be bent slightly to allow the secure coupling of the dispensing tube of a caulk gun with the attachment member of an embodiment of an adhesive-medium finishing tool. Another example is an injection-molded polymer or rubber attachment member of an embodiment of an adhesive-medium finishing tool in the shape of a tapered tube or funnel that is designed to receive the dispensing tube of a caulk gun and that causes a secure fit as the attachment member is slightly enlarged by the insertion of the dispensing tube.

The term “adhesive-medium-applicator tool” and similar terms, as used in this specification and the appended claims, refers to any device, tube, or vessel used to dispense adhesive medium in a controlled fashion. For the purposes of this disclosure, such devices have a source of adhesive medium, at least one elongated dispensing end from which adhesive medium can be discharged, and control means for a user to cause the adhesive medium to flow from the adhesive-medium source and out the dispensing end. The control means can be as simple as a user's hand squeezing a adhesive medium out of a tube. Examples of such devices are caulking guns, glue guns, tubes of caulk, tubes of glue or epoxy, etc.

### First Embodiment

### A Finishing Tool for Use with an Adhesive-Medium-Applicator Tool

This embodiment is directed generally to a device used to smooth and finish a bead of an adhesive medium that has been applied to a jointed surface within the same motion and operation of that of applying the bead of adhesive medium; that is, the finishing tool in this embodiment allows the application of and finishing of adhesive medium material in one step.

Using a caulking task as a non-limiting example, the device is coupled to the discharge end of a typical caulking gun or tube, and as a user causes the caulking gun or tube to discharge along a jointed surface, the device trails the applied caulk bead and both smoothes the caulk bead and gathers up the excess caulk in the same motion. Therefore, the caulking task can be performed in one step.

For convenient reference, much of this embodiment focuses on a caulking application. However, it is important to note that a caulking application is but one of myriad adhesive-medium applications that the embodiments described herein can be applied to. One ordinarily skilled in the art would easily appreciate that the finishing tool embodiments can be applied to caulk, resin, glue, epoxy, grout, drywall mud, and chinking, as well as any similar adhesive mediums.

Referring to FIGS. 1-10, a basic embodiment of a finishing tool 1 encompasses a flexibly rigid working member 8 having a first and a second working edge 2, and a third working edge 3. The working edges 2, 3 form a working interface on the working member 8. The first and second edges 2 are angled with respect to each other, with the angling being at an effective angle for a user-specified target jointed surface. The first and second working edges 2 are coupled via a third working edge 3, with the third edge 3 often being a substantially chamfered segment or rounded segment, which helps the quality of the finished seal. In some embodiments, the third working edge 3 can incorporate ridges to add longitudinal texture to the finished seal bead. Typically, the angle relationship between the first and second working edges 2 will be somewhere between 45 degrees and 90 degrees, though other angles (particularly larger angles) are possible for specialized jointed surfaces, with the general goal being to have an angling that will best allow the finishing tool 1 to capture excess adhesive medium, and to act as a guide for the user as the bead of adhesive medium is being laid between the two surfaces of the jointed interface.

The thickness of the first and second working edges are typically tapered such that the thinner part of each angled working edge 2 is oriented toward the coupling third edge 3. The material of the three working edges 2, 3 is adapted to pliably contact the surfaces of a target jointed surface. Often, the material used is a polymer or vulcanized rubber, but other materials, including composites, can be used.

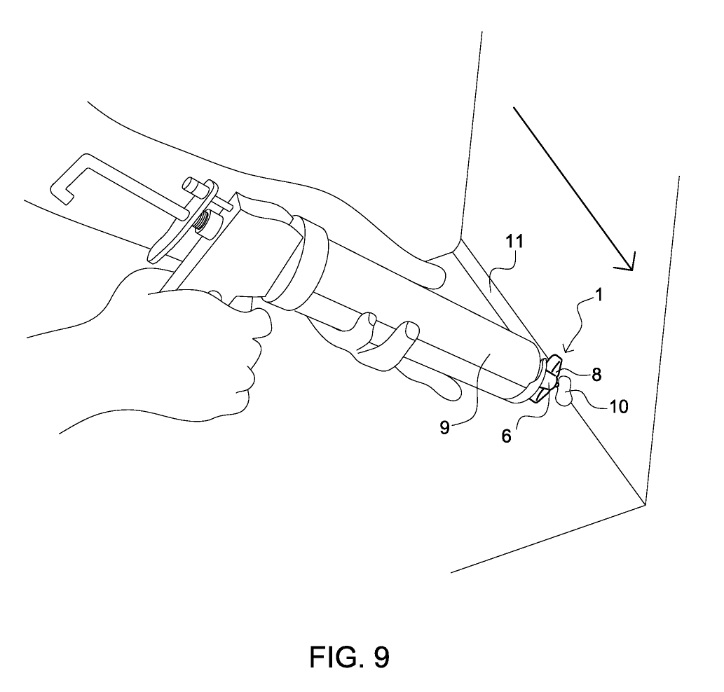

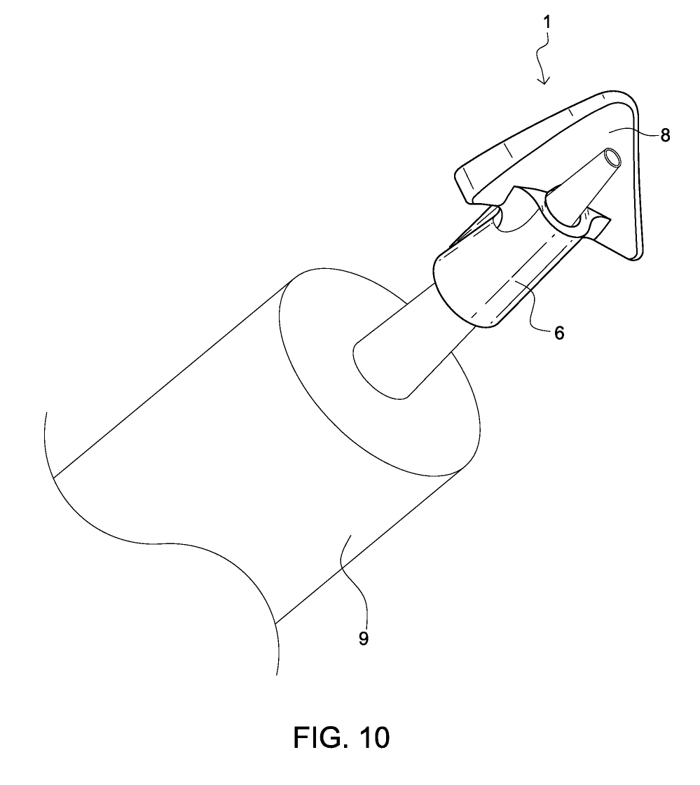

In many embodiments, the working member's leading working face 8, which is the face disposed closest to the dispensing end of an associated adhesive-medium-applicator tool 9, is slightly cupped or concaved in its front profile (as can be seen in FIGS. 1-5). This feature allows the finishing tool to trap and redistribute adhesive medium material 10 (see FIG. 9), such as caulk, as the adhesive-medium-applicator tool is used to lay a bead 11, which in turn facilitates less waste of adhesive medium material. That is, less material such as caulk is used to lay an effective bead.

Coupled to the non-working-edge side of the device is an attachment member 6 adapted to be coupled to a dispensing end of an adhesive-medium-applicator tool. In some embodiments, the coupling between the working member 8 and the attachment member 6 is structurally enhanced with the use of additional fabrication material along the bottom of the finishing tool 1 forming a spine 7 of sorts. In other embodiments, this spine 7 further incorporates a rigid rib material, such as a metal or hard-plastic strip.

In a typical embodiment, a tube-like attachment member 6 can be slidably coupled over the dispensing tube of an adhesive-medium-applicator tool, such as a common caulking gun. Aiding in this functionality is the fact that the receiving end of the attachment member 6 has a first opening 5 and a second opening 4, wherein the diameter of the attachment member 6 tapers down from the first opening 5 and the second opening 4. The material of the attachment member is such that the attachment member 6 enjoys a friction-based and/or interference-based coupling to the dispensing tube. Accordingly, those ordinarily skilled in the art will appreciate that such a fitting, combined with the use of material(s) that are somewhat flexible, allow for the attachment member 6 to be effectively attachable to variety of sizes of dispensing tube-like members of adhesive-medium-applicator tools. It should be noted that virtually any type of application device that has the same basic functionality can be used, as long as there is an elongated dispensing tube-like structure at the application end. For example, even a simple tube of caulking material can be used with the finishing tool 1, with no traditional caulking gun required.

The finishing tool 1 is adapted to be used with the adhesive-medium-applicator tool such that as adhesive medium is dispensed by a user along a target jointed surface, the finishing tool 1 working member 8 trails the dispensing end of the applicator tool and pliably interacts with the target jointed surface such that excess adhesive medium is gathered by the finishing tool 1 while smoothing out the seam of applied adhesive medium. During this operation, the three edges of the working interface 2, 3 make substantial contact with the surface area of both sides of the target jointed surface, generally leaving little or no opportunity for excess adhesive medium to be left anywhere but in the immediate crease of the target joint between the target surfaces. The flexible rigidness of the finishing tool 1 helps to facilitate this functionality.

In one embodiment, which is depicted in FIGS. 1-7, the finishing tool 1 is an injection-molded article of either a polymer or a rubber-type material. The actual sizing of the finishing tool 1 depends on the intended application, including the type and size of the adhesive-medium-applicator tool to be used, the size (including width) of the bead of adhesive medium material to be deposited along the target jointed surface, and the size and type of the desired finished bead of adhesive-medium material to be left behind after the application process. As but one of myriad possible examples, the finishing tool 1 can be scaled to easily fit a common medium-sized caulking gun caulk-tube-dispensing member, suitable for use around a typical consumer's home. In one such embodiment, the dimensions of the finishing tool 1 are: roughly a length of 2¼ in.; a extreme width between the first and second working edges 2 (distal from the third working edge 3) of roughly 1⅞ in; a thickness at the non-working end of each angled working edge 2 of roughly ⅜ in, which tapers down to the coupling with the third working edge 3 to a thickness of roughly 3/32 in. The attachment member 6 in this embodiment is roughly ¾ in. in diameter at the end most distal from the third working edge 3, and with a wall thickness of roughly 1/16 in. The attachment member 6 in this embodiment tapers down in diameter to roughly 9/16 in. in diameter. On ordinarily skilled in the art will appreciate that the dimensions of the finishing tool 1 in this embodiment are merely exemplary, and that the basic design of the finishing tool 1 can be scaled up or down easily and therefore such variations in dimensions are considered obvious variants of the basic inventive disclosure herein.

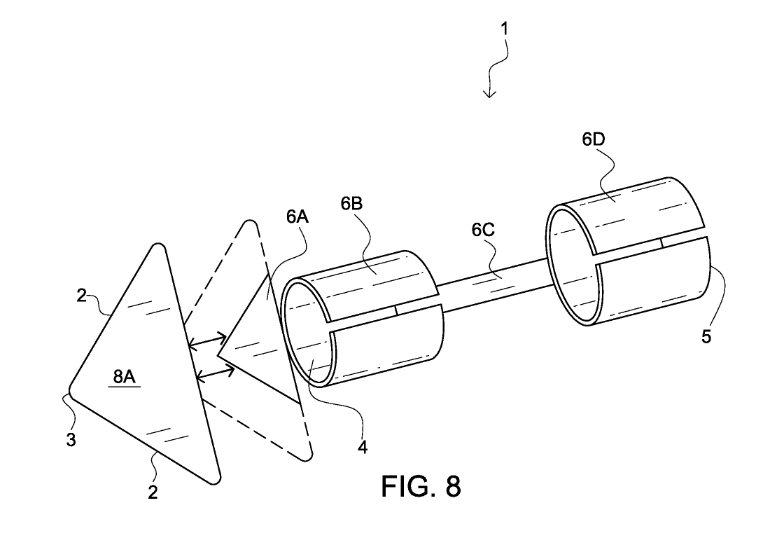

An option available to the embodiment is a means to change-out the working member 8 from the attachment member 6 and change-out the working member 8 of the finishing tool 1 for cleaning, maintenance, or selection of a differently-sized and/or shaped working member 8 for the application. See FIG. 8.

Another option used in some embodiments is to have a dial-blade configuration attached to the attachment member 6 such that a user can select a different working member (blade) 8 by merely turning the dial until the desired blade of the working member 8 snaps or locks fixedly into place in preparation for the application of adhesive medium.

### Second Embodiment

### A Finishing Tool for Use with an Adhesive-Medium Applicator

This embodiment is directed generally to a device used to smooth and finish a bead of an adhesive medium that has been applied to a jointed surface within the same motion and operation of that of applying the bead of adhesive medium; that is, the finishing tool in this embodiment allows the application of and finishing of adhesive medium material in one step. Refer to FIGS. 1-10.

In this embodiment, the finishing tool 1 is used in conjunction with an adhesive-medium-applicator tool. The applicator tool, such as a common caulking gun 9 (see FIGS. 9 and 10), has a source of adhesive medium (such a cartridge tube of caulk), a dispensing end, and a control means for a user to cause the adhesive medium to flow from the adhesive-medium source and out the dispensing end. This control means can be a simple as a user's ability to hand-squeeze adhesive medium out of a squeezable tube of such adhesive medium material. The dispensing end has an elongated and substantially tube-like member for depositing the adhesive medium onto a target jointed surface.

The finishing tool 1, which can be fixedly manufactured as a unit with the applicator tool or, in many embodiments, can be attached to the applicator tool as an after-market enhancement to the applicator tool, comprises a flexibly rigid working member 8 having a first, second, and third working edge 2, 3, where the working edges 2, 3 form a working interface, and a substantially rigid attachment member 6 adapted to be coupled to a dispensing end of an adhesive-medium-applicator tool. The first and second edges 2, 3 are angled with respect to each other, with the angling being at an effective angle for a user-specified target jointed surface. The first and second working edges 2 are coupled via the third working edge 3, with the third edge 3 being a chamfered segment or rounded segment, which helps form a proper finish to an applied bead of adhesive-medium material. The thicknesses of the first and second working edges 2 are tapered such that the thinner part of each working edge 2 is oriented toward the coupling third edge 3. The material of the three working edges 2, 3 are adapted to pliably contact the surfaces of a target jointed surface. The attachment member 6 is coupled to the working member 8 at a point that does not interfere with the first, second, and third working edges 2, 3. This structural arrangement thereby results in a finishing tool 1 is adapted to be used with an adhesive-medium-applicator tool such that as adhesive medium is dispensed by a user along a target jointed surface, the finishing tool 1 working member 8 trails the dispensing end of the applicator tool and pliably interacts with the target jointed surface such that excess adhesive-medium material is gathered by the finishing tool 1 while smoothing out the seam of applied adhesive medium.

This embodiment can be further enhanced wherein the finishing tool 1 is substantially comprised of polymer material, vulcanized rubber material, and/or composite material.

This embodiment can be further enhanced wherein a composite material used includes (1) a polymer or vulcanized rubber, and (2) at least one metal or hard-plastic rib support, wherein the rib support(s) is(are) longitudinally overmolded within the polymer or vulcanized rubber material in order to add rigidity to the attachment member 6 and the working member 8. Such rib supports can provide added rigidness when especially light-weight and pliable materials are used to manufacture the finishing tool 1, particularly many materials that might be used in an injection-molding manufacturing process.

This embodiment can be further enhanced wherein composited material used includes (1) a polymer or vulcanized rubber for the working member 8, and (2) a metal framework for the attachment member 6. In some embodiments, the metal framework can facilitate a clamping-type of coupling between the finishing tool 1 and the dispensing end of an adhesive-medium-applicator tool.

This embodiment can be further enhanced wherein the attachment member 6 is a flexible tube-like structure adapted to receive a dispensing-tube-like member of an adhesive-medium-applicator tool, and adapted to frictionally grip a dispensing-tube-like member of an adhesive-medium-applicator tool.

This embodiment can be further enhanced wherein the attachment member 6 is a flexible clamp-like structure adapted to receive a dispensing-tube-like member of an adhesive-medium-applicator tool, adapted to compressively and/or frictionally grip a dispensing-tube-like member of an adhesive-medium-applicator tool.

This embodiment can be further enhanced wherein the attachment member 6 is fixedly coupled to a dispensing-tube-like member of an adhesive-medium-applicator tool using a continuous-type fastening. In some embodiments, such continuous-type fastening can be metallic welding, thermoplastic welding, and/or adhesive application.

This embodiment can be further enhanced wherein the attachment member 6 is coupled to the dispensing end of an adhesive-medium-applicator tool by fabricating the attachment member 6 and said dispensing end together as one unit.

This embodiment can be further enhanced wherein the first, second, and third working edges 2, 3 are beveled.

This embodiment can be further enhanced wherein the attachment member 6 further comprises a mounting member (see FIG. 8) 6A adapted to allow the readily detachable coupling of the working member (see FIG. 8) 8A with the attachment member 6A-6D. Thus, this enhancement allows a user to change-out a worn-out or damaged working member 8A with another working member, as necessary. It also allows a user to change-out a working member 8A with another working member 8A of differing size and/or shape, as necessary. Finally, it allows a user to remove a working member 8A for cleaning and/or maintenance, as necessary.

This embodiment can be further enhanced wherein the working member 8 further comprises at least one additional working interface 2, 3 and a dial-type working-interface-selection device on the coupling with the attachment member 6, wherein the plurality of working interfaces are substantially evenly spaced around the dial-type working-interface-selection device, which is adapted to allow a user to selectively and fixedly position the user-desired working interface 2, 3 toward the working end of the finishing tool 1 for use during the application of adhesive medium.

This embodiment can be further enhanced wherein the leading face of the working member 8 is concaved such that the working member 8 is adapted to trap and redistribute adhesive medium as the finishing tool 1 is used.

This embodiment can be further enhanced wherein the finishing tool 1 is adapted to apply an adhesive medium is selected from the group comprising caulking, resin, glue, epoxy, grout, drywall mud, and chinking.

### Third Embodiment

### A Method for Making a Finishing Tool for Use with an Adhesive-Medium Applicator

This embodiment is directed generally to a method of making a device used to smooth and finish a bead of an adhesive medium that has been applied to a jointed surface within the same motion and operation of that of applying the bead of adhesive medium; that is, the finishing tool in this embodiment allows the application of and finishing of adhesive medium material in one step. Refer to FIGS. 1-10.

In this embodiment, the method makes a finishing tool 1 to be used in conjunction with an adhesive-medium-applicator tool. The applicator tool, such as a common caulking gun 9 (see FIGS. 9 and 10), has a source of adhesive medium (such a cartridge tube of caulk), a dispensing end, and a control means for a user to cause the adhesive medium to flow from the adhesive-medium source and out the dispensing end. This control means can be a simple as a user's ability to hand-squeeze adhesive medium out of a squeezable tube of such adhesive medium material. The dispensing end has an elongated and substantially tube-like member for depositing the adhesive medium onto a target jointed surface.

The method of making the finishing tool 1 comprises the steps of providing a flexibly rigid working member 8 having a first, second, and third working edge 2, 3, where the working edges 2, 3 form a working interface, and providing a substantially rigid attachment member 6 adapted to be coupled to a dispensing end of an adhesive-medium-applicator tool. The first and second edges 2, 3 are angled with respect to each other, with the angling being at an effective angle for a user-specified target jointed surface. The first and second working edges 2 are coupled via the third working edge 3, with the third edge 3 being a chamfered segment or rounded segment, which helps form a proper finish to an applied bead of adhesive-medium material. The thicknesses of the first and second working edges 2 are tapered such that the thinner part of each working edge 2 is oriented toward the coupling third edge 3. The material of the three working edges 2, 3 are adapted to pliably contact the surfaces of a target jointed surface. The attachment member 6 is coupled to the working member 8 at a point that does not interfere with the first, second, and third working edges 2, 3. This structural arrangement thereby results in a finishing tool 1 is adapted to be used with an adhesive-medium-applicator tool such that as adhesive medium is dispensed by a user along a target jointed surface, the finishing tool 1 working member 8 trails the dispensing end of the applicator tool and pliably interacts with the target jointed surface such that excess adhesive-medium material is gathered by the finishing tool 1 while smoothing out the seam of applied adhesive medium.

This embodiment can be further enhanced wherein the finishing tool 1 is substantially comprised of polymer material, vulcanized rubber material, and/or composite material.

This embodiment can be further enhanced wherein a composite material used includes (1) a polymer or vulcanized rubber, and (2) at least one metal or hard-plastic rib support, wherein the rib support(s) is(are) longitudinally overmolded within the polymer or vulcanized rubber material in order to add rigidity to the attachment member 6 and the working member 8. Such rib supports can provide added rigidness when especially light-weight and pliable materials are used to manufacture the finishing tool 1, particularly many materials that might be used in an injection-molding manufacturing process.

This embodiment can be further enhanced wherein composited material used includes (1) a polymer or vulcanized rubber for the working member 8, and (2) a metal framework for the attachment member 6. In some embodiments, the metal framework can facilitate a clamping-type of coupling between the finishing tool 1 and the dispensing end of an adhesive-medium-applicator tool.

This embodiment can be further enhanced wherein the attachment member 6 is a flexible tube-like structure adapted to receive a dispensing-tube-like member of an adhesive-medium-applicator tool, and adapted to frictionally grip a dispensing-tube-like member of an adhesive-medium-applicator tool.

This embodiment can be further enhanced wherein the attachment member 6 is a flexible clamp-like structure adapted to receive a dispensing-tube-like member of an adhesive-medium-applicator tool, adapted to compressively and/or frictionally grip a dispensing-tube-like member of an adhesive-medium-applicator tool.

This embodiment can be further enhanced wherein the attachment member 6 is fixedly coupled to a dispensing-tube-like member of an adhesive-medium-applicator tool using a continuous-type fastening. In some embodiments, such continuous-type fastening can be metallic welding, thermoplastic welding, and/or adhesive application.

This embodiment can be enhanced by further comprising the step of fabricating the attachment member 6 with the dispensing end of an adhesive-medium-applicator tool together as one fixedly coupled unit.

This embodiment can be further enhanced wherein the first, second, and third working edges 2, 3 are beveled.

This embodiment can be enhanced by further comprising the step of providing a mounting member (see FIG. 8) 6A on the attachment member 6 adapted to allow the readily detachable coupling of the working member (see FIG. 8) 8A with the attachment member 6A-6D. Thus, this enhancement allows a user to change-out a worn-out or damaged working member 8 with another working member, as necessary. It also allows a user to change-out a working member 8A with another working member 8A of differing size and/or shape, as necessary. Finally, it allows a user to remove a working member 8A for cleaning and/or maintenance, as necessary. This enhancement can be extended by further comprising the step of providing at least one readily detachable working member 8A

This embodiment can be enhanced by further comprising the steps of providing for the working member 8 at least one additional working interface 2, 3 and providing a dial-type working-interface-selection device on the coupling with the attachment member 6, wherein the plurality of working interfaces are substantially evenly spaced around the dial-type working-interface-selection device, which is adapted to allow a user to selectively and fixedly position the user-desired working interface 2, 3 toward the working end of the finishing tool 1 for use during the application of adhesive medium.

This embodiment can be further enhanced wherein the leading face of the working member 8 is concaved such that the working member 8 is adapted to trap and redistribute adhesive medium as the finishing tool 1 is used.

This embodiment can be further enhanced wherein the finishing tool 1 is adapted to apply an adhesive medium is selected from the group comprising caulking, resin, glue, epoxy, grout, drywall mud, and chinking.

### Fourth Embodiment

### A Method for Using a Finishing Tool Adapted for Use with an Adhesive-Medium Applicator

This embodiment is directed generally to a method of using a device used to smooth and finish a bead of an adhesive medium that has been applied to a jointed surface within the same motion and operation of that of applying the bead of adhesive medium; that is, the finishing tool in this embodiment allows the application of and finishing of adhesive medium material in one step. Refer to FIGS. 1-10. The method assumes that the finishing tool 1 conforms with the First and/or Second Embodiments described supra, or an obvious variation thereof.

The basic method comprises the steps of:
Selecting a target jointed surface to apply an adhesive medium;
Contacting the target jointed surface with one or more working edges of the working interface 2, 3;
Dispensing adhesive medium 10 (see FIG. 9) with the applicator tool 9 (see FIGS. 9 and 10) equipped with the finishing tool 1, while moving the applicator tool/finishing tool assembly along the target jointed surface, forming a finished bead of adhesive medium 11 (see FIG. 9),
   Wherein the tip of the dispensing end of the applicator tool is substantially and longitudinally extended down the face of said working member 8, that working-member face being considered the leading face of the working member 8 as adhesive medium is applied, and
   Wherein as the working member 8 trails the dispensing end of the applicator tool and pliably interacts with the target jointed surface such that excess adhesive medium is gathered by the finishing tool 1 while smoothing out the seam of applied adhesive medium; and
As necessary, stopping said application of adhesive medium to allow a user to clean said finishing tool, then resuming as necessary the application of adhesive medium.

This embodiment can be further enhanced wherein the attachment member 6 is a flexible tube-like structure adapted to receive a dispensing-tube-like member of an adhesive-medium-applicator tool, and adapted to frictionally grip a dispensing-tube-like member of an adhesive-medium-applicator tool. In this enhancement, the method further comprises the step of, before the step of contacting the target jointed surface, inserting and securely seating the dispensing tip of the applicator tool inside the attachment member 6 of said finishing tool 1, thereby joining the adhesive-medium-applicator tool and the finishing tool 1 as a unit.

This embodiment can be further enhanced wherein the attachment member 6 is a flexible clamp-like structure adapted to receive a dispensing-tube-like member of an adhesive-medium-applicator tool, adapted to compressively and/or frictionally grip a dispensing-tube-like member of an adhesive-medium-applicator tool. In this enhancement, the method further comprises the step of, before the step of contacting the target jointed surface, inserting and securely seating the dispensing tip of the applicator tool inside the attachment member 6 of the finishing tool 1, thereby joining the adhesive-medium-applicator tool and the finishing tool 1 as a unit.

This embodiment can be further enhanced wherein the attachment member 6 further comprises a mounting member (see FIG. 8) 6A adapted to allow the readily detachable coupling of the working member (see FIG. 8) 8A with the attachment member 6A-6D. In this enhancement, the method further comprises the steps of:
As necessary, change-out a worn-out or damaged working member 8A with another working member 8A;
As necessary, change-out a working member 8A with another working member 8A of differing size and/or shape; and
As necessary, remove a working member 8A for cleaning and/or maintenance.

This embodiment can be further enhanced wherein the working member 8 further comprises at least one additional working interface 2, 3 and a dial-type working-interface-selection device on the coupling with the attachment member 6, wherein the plurality of working interfaces are substantially evenly spaced around the dial-type working-interface-selection device, which is adapted to allow a user to selectively and fixedly position the user-desired working interface 2, 3 toward the working end of the finishing tool 1 for use during the application of adhesive medium. In this enhancement, the method further comprises the step of:
Before the step of contacting the targeted jointed surface, selectively and fixedly positioning the desired working interface 2, 3 toward the working end of the finishing tool 1 for use during the application of adhesive medium.

### ALTERNATIVE EMBODIMENTS AND OTHER VARIATIONS

The various embodiments and variations thereof described herein and/or illustrated in the accompanying Figures are merely exemplary and are not meant to limit the scope of the inventive disclosure. It should be appreciated that numerous variations of the invention have been contemplated as would be obvious to one of ordinary skill in the art with the benefit of this disclosure.

Hence, those ordinarily skilled in the art will have no difficulty devising myriad obvious variations and improvements to the invention, all of which are intended to be encompassed within the scope of the claims which follow.

What is claimed is:

1. A tool for finishing the application of an adhesive medium in a substantially simultaneous one-step process with said application of said adhesive medium, said application of an adhesive medium accomplished by using an adhesive-medium-applicator tool; the finishing tool comprising:
a flexibly rigid working member having a first, second, and third working edge, said working edges forming a working interface,
wherein said first and second edges are angled with respect to each other, said angling being at an effective angle for a user-specified target jointed surface,
wherein said first and second working edges are coupled via said third working edge, said third edge being a chamfered segment or rounded segment,
wherein the thicknesses of said first and second working edges are tapered such that the thinner part of each working edge is oriented toward said coupling third edge, and
wherein the material of said three working edges are adapted to pliably contact the surfaces of a target jointed surface; and
a substantially rigid attachment member adapted to be coupled to a dispensing end of an adhesive-medium-applicator tool,
wherein said attachment member is coupled to said working member at a point that does not interfere with said first, second, and third working edges.

2. The finishing tool of claim 1, wherein the finishing tool is substantially comprised of polymer material.

3. The finishing tool of claim 1, wherein the finishing tool is substantially comprised of vulcanized rubber material.

4. The finishing tool of claim 1, wherein the finishing tool is substantially comprised of composite material.

5. The finishing tool of claim 4, wherein said composite material includes:
a polymer or vulcanized rubber; and
at least one rib support made of metal or hard plastic,
wherein said at least one rib support is overmolded within said polymer or vulcanized rubber material in order to add rigidity to said attachment member and said working member.

6. The finishing tool of claim 4, wherein said composite material includes:
a polymer or vulcanized rubber for said working member; and
a metal framework for said attachment member.

7. The finishing tool of claim 1, wherein:
said attachment member is a flexible tube-like structure;
said attachment member is adapted to receive a dispensing-tube-like member of an adhesive-medium-applicator tool; and
said attachment member adapted to grip a dispensing-tube-like member of an adhesive-medium-applicator tool.

8. The finishing tool of claim 1, wherein:
said attachment member is a flexible clamp-like structure;
said attachment member is adapted to receive a dispensing-tube-like member of an adhesive-medium-applicator tool; and
said attachment member adapted to grip a dispensing-tube-like member of an adhesive-medium-applicator tool.

9. The finishing tool of claim 1, wherein said attachment member is fixedly coupled to a dispensing-tube-like member of an adhesive-medium-applicator tool using a continuous-type fastening.

10. The finishing tool of claim 9, wherein said continuous-type fastening is selected from the group consisting of metallic welding, thermoplastic welding, and adhesive application.

11. The finishing tool of claim 1, wherein said attachment member is coupled to the dispensing end of an adhesive-medium-applicator tool by fabricating said attachment member and said dispensing end together as one unit.

12. The finishing tool of claim 1, wherein said first, second, and third working edges are beveled.

13. The finishing tool of claim 1, wherein said attachment member further comprises a mounting member adapted to allow the readily detachable coupling of said working member with said attachment member.

14. The finishing tool of claim 1, wherein the leading face of said working member is concaved such that said working member is adapted to trap and redistribute adhesive medium as said finishing tool is used.

15. The finishing tool of claim 1, wherein said tool is adapted to apply an adhesive medium is selected from the group comprising caulking, resin, glue, epoxy, grout, drywall mud, and chinking.

16. A method of making a tool for finishing the application of an adhesive medium in a substantially simultaneous one-step process with said application of said adhesive medium, said application of an adhesive medium accomplished by using an adhesive-medium-applicator tool; the method comprising the steps of:
providing a flexibly rigid working member having a first, second, and third working edge, said working edges forming a working interface,
wherein said first and second edges are angled with respect to each other, said angling being at an effective angle for a user-specified target jointed surface,
wherein said first and second working edges are coupled via said third working edge, said third edge being a chamfered or rounded segment,
wherein the thicknesses of said first and second working edges are tapered such that the thinner part of each working edge is oriented toward said coupling third edge, and
wherein the material of said three working edges are adapted to pliably contact the surfaces of a target jointed surface; and
providing a substantially rigid attachment member adapted to be coupled to a dispensing end of an adhesive-medium-applicator tool,
wherein said attachment member is coupled to said working member at a point that does not interfere with said first, second, and third working edges.

17. The method of claim 16, further comprising the step of fabricating said attachment member with the dispensing end of an adhesive-medium-applicator tool together as one fixedly coupled unit.

18. The method of claim 16, further comprising the step of providing a mounting member on said attachment member adapted to allow the readily detachable coupling of said working member with said attachment member.

19. The method of claim 18, further comprising the step of providing at least one readily detachable working member.

20. A method of using a tool for finishing the application of an adhesive medium in a substantially simultaneous one-step process with said application of said adhesive medium according to claim 1; the method comprising the steps of:
selecting a target jointed surface to apply an adhesive medium;
contacting said target jointed surface with one or more working edges of said working interface;
dispensing adhesive medium with said applicator tool equipped with said finishing tool, while moving said applicator tool/finishing tool assembly along said target jointed surface,
wherein the tip of the dispensing end of said adhesive-medium-applicator tool is substantially and longitudinally extended down the face of said working member, said working-member face being the leading face of said working member as adhesive medium is applied, and
wherein as said working member trails the dispensing end of said applicator tool and pliably interacts with said target jointed surface such that excess adhesive medium is gathered by said finishing tool while smoothing out the seam of applied adhesive medium; and
as necessary, stopping said application of adhesive medium to allow a user to clean said finishing tool, then resuming as necessary the application of adhesive medium.

21. The method of claim 20, wherein:
said attachment member is a flexible tube-like structure;
said attachment member is adapted to receive a dispensing-tube-like member of an adhesive-medium-applicator tool; and
said attachment member adapted to grip a dispensing-tube-like member of an adhesive-medium-applicator tool;
the method further comprising the step of, before the step of contacting said target jointed surface, inserting and securely seating the dispensing tip of said adhesive-medium-applicator tool inside said attachment member of said finishing tool,
thereby joining said adhesive-medium-applicator tool and said finishing tool as a unit.

22. The method of claim 20, wherein:
said attachment member is a flexible clamp-like structure;
said attachment member is adapted to receive a dispensing-tube-like member of an adhesive-medium-applicator tool; and
said attachment member adapted to grip a dispensing-tube-like member of an adhesive-medium-applicator tool;
the method further comprising the step of, before the step of contacting said target jointed surface, inserting and securely seating the dispensing tip of said adhesive-medium-applicator tool inside said attachment member of said finishing tool,
thereby joining said adhesive-medium-applicator tool and said finishing tool as a unit.

23. The method of claim 20, wherein said attachment member further comprises a mounting member adapted to allow the readily detachable coupling of said working member with said attachment member, the method further comprising the steps of:
as necessary, change-out a worn-out or damaged working member with another working member;
as necessary, change-out said working member with another working member of differing size and/or shape; and
as necessary, remove said working member for cleaning and/or maintenance.
